(19) United States
(12) Patent Application Publication
(10) Pub. No.: US 2026/0234475 A1
(43) Pub. Date: Aug. 13, 2026

(54) SYNTHESIS OF HYDROGEN GAS BY FLASH JOULE HEATING

(71) Applicant: William Marsh Rice University, Houston, TX (US)

(72) Inventors: James M. TOUR, Houston, TX (US); Kevin WYSS, Houston, TX (US); Yi CHENG, Houston, TX (US); Karla J. SILVA, Houston, TX (US); Lucas EDDY, Houston, TX (US)

(73) Assignee: WILLIAM MARSH RICE UNIVERSITY, Houston, TX (US)

(21) Appl. No.: 19/164,489

(22) PCT Filed: Mar. 14, 2024
(86) PCT No.: PCT/US2024/019867

§ 371 Date: Sep. 11, 2025

Related U.S. Application Data
(60) Provisional application No. 63/452,069, filed on Mar. 14, 2023.
(60) Provisional application No. 63/595,646, filed on Nov. 2, 2023.

(51) Int. Cl. C10B 53/07; C01B 32/956

(52) U.S. Cl. CPC C10B 53/07; C01B 32/956; C01P 2004/13

(57) ABSTRACT

Method and systems for the synthesis of hydrogen gas by flash Joule heating, such as synthesizing hydrogen gas from waste plastic materials, other solid materials, or liquid materials by flash Joule heating.

### CROSS-REFERENCE TO RELATED PATENT APPLICATIONS

The application claims priority to: (1) U.S. Patent Appl. Ser. No. 63/452,069, filed Mar. 14, 2023, entitled “Methods And Systems For Catalyst-Free. High-Yield Production Of Hydrogen Gas From Waste By Flash Joule Heating;” and (2) U.S. Patent Appl. Serial No. 63/595,646, filed Nov. 2, 2023, entitled “Synthesis Of Hydrogen Gas From Waste Plastic Materials By Flash Joule Heating.”

The methods and systems of the present invention are also related to PCT Patent Appl. Serial Nos. PCT/US21/52030, PCT/US21/52043, PCT/US21/52057, and PCT/US21/52070, to James M. Tour et al., each entitled “Ultrafast Flash Joule Heating Synthesis Methods And Systems For Performing Same,” each filed Sep. 24, 2021, and each claiming priority to U.S. Patent Appl. Ser. No. 63/082,592, filed Sep. 24, 2020.

Each of these patent applications is commonly owned by the owner of the present invention and is incorporated herein in its entirety

### GOVERNMENT INTEREST

This invention was made with government support under Grant No. FA9550-22-1-0526, awarded by the United States Air Force Office of Scientific Research, Grant No. W912HZ-21-2-0050, awarded by the United States Army Corps of Engineers, Engineer Research and Development Center, and Grant No. 1842494, awarded by the National Science Foundation. The United States government has certain rights in the invention.

### TECHNICAL FIELD

The present invention relates to methods and systems for the synthesis of hydrogen gas by flash Joule heating, such as synthesizing hydrogen gas from waste plastic materials, other solid materials, or liquid materials by flash Joule heating.

### BACKGROUND

Hydrogen has emerged as a promising clean and environmental energy resources, capable of powering various sectors including transportation, industry, and electricity generation, especially when facing the challenges of climate change and dwindling fossil fuel resources. Over 90 million metric tons (MMT) per year of hydrogen gas (H₂) is used in oil refining and ammonia synthesis. [Velazquez 2017]. H₂ is also the primary storable fuel of the global shift toward green, pollution-free efficient energy production through its use in fuel cells to generate electricity plus water, or through direct combustion to produce water. [Abe 2019].

Current hydrogen synthesis methods, including methane reforming, methane pyrolysis and water electrolysis, suffer from low efficiency, high energy consumption, high greenhouse gas emissions and often require precise metal catalysts, while no value-added co-products were synthesized. [Grogoriev 2020; van Rennsen 2020]. More than 95% of H₂ produced globally is synthesized through metal-catalyzed steam methane reforming that produces stoichiometric amounts of CO₂ during the H₂ generation, while consuming non-renewable fossil fuel feedstocks. [Nikolaidis 2017]. Steam methane reforming to produce H₂, also known as “grey hydrogen” production, is responsible for 800 MMT annually of CO₂ production, equal to all the CO₂ emissions of the United Kingdom. [Holladay 2009]. H₂ demand is projected to grow rapidly throughout the next three decades (FIG. 1A), so alternative production methods are needed to avoid further increases in CO₂ production.

Electrolysis of water to produce H₂ and O₂ presents one such pathway, producing no greenhouse gases when powered by renewable energy. [Dincer 2012]. Disappointingly, despite current emissions consciousness, the proportion of H₂ produced by electrolysis has not increased and fossil fuels remain integral to H₂ production (FIG. 1B). One explanation for the slow development of electrolysis production methods is the requisite high-cost metal catalysts, such as Pt, Ir, or Ru, and the freshwater needed for its electrochemical conversion into H₂ and O₂. [Shiva Kumar 2022] For every 1 kg of H₂ produced, 9 kg of water is consumed, limiting implementation of electrolysis in some climates. [Besqick 2021]. Since H₂ produced by electrolysis typically costs 3-5× more than H₂ produced from steam methane reforming, it is economically difficult for electrolysis to gain a market foothold. [Hermesmann 2022]. High-temperature methane pyrolysis, known as turquoise hydrogen, and steam methane reforming with associated CO₂ capture, known as blue hydrogen, do not result in the release of stoichiometric greenhouse gases, but they both face similar high costs and still require fossil-fuel feedstocks. [Timmerberg 2020].

Therefore, cost-effective methods for hydrogen synthesis method are highly desirable for widespread usage of hydrogen. H₂ production methods are needed that evolve little CO₂, require no costly catalysts, and use globally abundant feedstocks. The co-production of H₂ with high-value materials could afford an economic competition to displace steam methane reforming (FIG. 1C).

Plastic materials, including plastic and plastic-containing composite materials, are used extensively throughout the world from beverage containers to architecture-reinforced components. Currently, 4.9 billion tonnes of waste plastics are generated annually, and most of it was directly landfilled. Moreover, waste plastic is estimated to increase to around 12 billion tonnes by 2050, posing immense pressure to environment. [Lopez 2017; Geyer 2017]. Considering that plastic often contains 0.5-15 wt % of hydrogen atoms, plastic provides a substantial resource for hydrogen generation. [Jie 2020: Barbarias 2016]. However, 95% of the waste plastic generated annually is never recycled due to the high cost of plastic-type separation. [Al-Salem 2017]. Hence, several technologies have viewed waste plastic as a potential source of H₂. [Jie 2020]. Typically, a two-step process involving catalytic pyrolysis or gasification converts waste plastics into small hydrocarbons, followed by steam reforming to yield H₂, CO, and ~12 kgs of CO₂ per 1 kg of H₂. [Williams 2021].

Accordingly, there is also a need to recycle waste plastic, including as a feedstock for hydrogen synthesis.

### SUMMARY OF INVENTION

The present invention relates to methods and systems for the synthesis of hydrogen gas from waste plastic materials by flash Joule heating.

In general embodiments, the present invention is directed a method that includes producing hydrogen gas from solid material using flash Joule heating.

Implementations of the invention can include one or more of the following features:

The solid material can be a waste product.

The solid material can be plastic.

The plastic can be one or a mixture of the following: polyethylene, high density polyethylene, low density polyethylene, polyethylene terephthalate, polystyrene, polybutadiene, polyacrylonitrile, a nylon, a polyester, polypropylene, a vinyl polymer, a step growth polymer, a chain growth polymer, a thermoplastic, a thennoset, a rubber, a living polymer, a ring-opening polymer, a siloxane polymer, a block polymer, a block copolymer, an inorganic polymer, and an organic polymer.

The solid material can be cellulosic.

The cellulosic material can be derived from any one or combination of the following: wood, paper, cardboard, trees, plants, household waste, municipal waste, and industrial waste.

The cellulosic material can be further thermally pre-treated prior to the flash Joule heating reaction.

The thermally pre-treated material can be biochar.

The materials to be treated can be waste materials.

The method can co-produce one or more of the following: graphene, carbon nanotubes, 1-dimensional materials, amorphous carbon, graphite, nanodiamond, and silicon carbide.

The method can co-produce silicon carbide that is 1D nanofibrils, nanotubes, and/or nanowhiskers.

The method can co-produce silicon carbide 3D particles.

The graphene can be co-produced. The graphene can be predominantly turbostratic or Bemal (AB-stacked) stacked, or mixtures of turbostratic and Bernal (AB-stacked) stacked.

The hydrocarbons can be co-produced.

The hydrocarbons can include one or more of the following: methane, ethane, propane, butane, pentane and hexane.

The hydrocarbons can include one or more of the branched isomers of: butane, pentane, and hexane.

The hydrocarbons can include alkenes, alkynes, aromatics, or mixtures thereof.

The carbon monoxide, carbon dioxide, or mixtures thereof can be co-produced.

One or more of flash graphene, carbon nanotubes, 1-dimensional materials, amorphous carbon, graphite, nanodiamond, and silicon carbide can be co-produced.

The heteroatom-containing graphenes can be co-produced.

The heteroatoms could be one or a mixture of the following: B, N, O, F, S, Si, and P.

The heteroatoms could be one or a mixture of metals atoms.

The solid material can be selected from the group consisting of coal, a coal derivative, a petroleum derivative, a petroleum product, a carbon-containing material, glass mixed with plastic, glass fiber plus plastic, glass fiber plus carbon fiber, and combinations thereof.

The flash Joule heating can be performed catalyst-free.

The flash Joule heating can be performed with a catalyst.

The catalyst can be a Fe-containing catalyst.

The Fe-containing catalyst can be iron chloride.

The catalyst can be selected from the group consisting of iron chloride, ferrocene, mixtures of iron chloride/nickel chloride, cobalt salts, cobalt oxides and combinations thereof.

In general embodiments, the present invention is directed a method that includes producing hydrogen gas from a material using flash Joule heating. The material includes a liquid that has hydrogen atoms chemically present.

Implementations of the invention can include one or more of the following features:

The liquid can have carbon and hydrogen chemically present.

The liquid can be selected from the group consisting of crude oil, oil, asphalt, and combinations thereof.

The liquid can be absorbed on a sponge.

The sponge can be selected from the group of carbon-based sponges, carbohydrate sponges, glass-based sponges, ceramic-based sponges, and combinations thereof.

The flash Joule heating can be performed catalyst-free.

The flash Joule heating can be performed using a catalyst.

### BRIEF DESCRIPTION OF THE DRAWINGS

FIGS. 1A-1C show the current state of hydrogen production and projected demand.

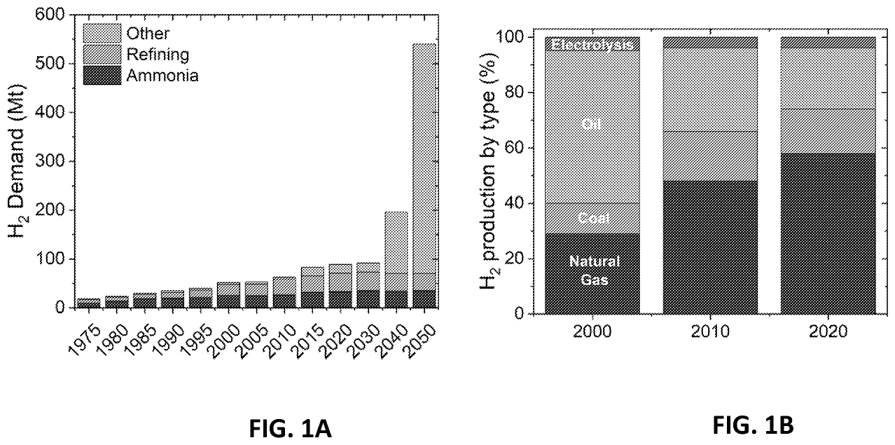

FIG. 1A shows historic and projected demand for H₂, separated by use. FIG. 1B shows the source of hydrogen historically produced, separated by feedstock. FIG. 1C shows a scheme comparing current H₂ production methods with the synthesis of hydrogen by flash Joule heating (FJH) as disclosed and described herein.

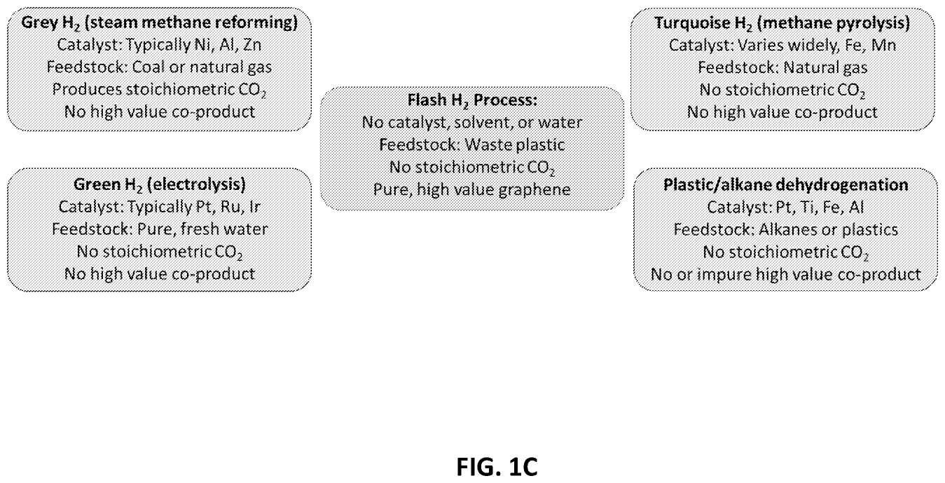

FIGS. 2A-2E show catalyst-free deconstruction of polyethylene to yield hydrogen and graphene. FIG. 2A is a schematic showing the typical flash Joule heating process used. FIG. 2B shows the resistance of plastic sample before treatment and peak temperature reached during FJH treatment as a function of conductive carbon mixed with waste polyethylene. FIG. 2C shows an investigation of how initial sample resistance impacts hydrogen yield and hydrogen efficiency in the FJH deconstruction of polyethylene. FIG. 2D shows how initial sample resistance impacts the gaseous products and yield of H₂ and graphene resulting from polyethylene deconstruction, where the bar graph corresponds to partial pressure of gas, while the line graph corresponds to the yield of H₂ or graphene compared to the amount of atomic H and C present in the starting mixture. FIG. 2E shows complete mass balance of polyethylene deconstruction as resistance varies.

FIG. 3 shows carbon and hydrogen contents in different precursors.

FIGS. 4A-4B shows setup for hydrogen synthesis by FJH. FIG. 4A shows a schematic of FJH process. FIG. 4B shows a picture of the FJH jig and hydrogen capture device.

FIGS. 5A-5F show process generality for other waste polymers, mixtures, and low-cost conductive additives. FIGS. 5A and 5C show hydrogen yield and efficiency as (a) polymer identity or (c) conductive additive is varied. FIGS. 5B and 5D show gaseous products evolved, with hydrogen and graphene yield calculated, as (b) polymer identity (d) or conductive additive is varied. The bar graph corresponds to partial pressure of gas, while the line graph corresponds to the yield of H₂ or graphene compared to the amount of atomic H and C present in the starting mixture. FIGS. 5E-5F show average Raman spectrum (100 unique spectra, over a 1 mm² area) as (e) polymer identity or (f) conductive additive is varied.

FIG. 6 shows GC-TCD spectra for HDPE samples with different Fe loading contents.

FIG. 7 shows GC-TCD spectra for HDPE samples with different catalyst loading.

FIGS. 8A-8D shows GC-TCD spectra for different samples from graphene synthesis (FIG. 8A), CNT synthesis (FIG. 8B), amorphous carbon synthesis (FIG. 8C), and SiC synthesis (FIG. 8D).

FIGS. 9A-9F is a characterization of polyethylene derived graphene.

FIGS. 10A-10C show characterizations of graphene. FIGS. 10A-10B are Raman spectrum. FIG. 10C are XRD patterns. (PDF card for graphene: 00-056-0159).

FIG. 11A-11D shows characterizations of flashed CNT, FIG. 11A is an SEM image; FIG. 11B is a TEM image; FIG. 11C is XPS spectrum; and FIG. 11D is Raman spectrum.

FIGS. 12A-12C shows characterizations of flash amorphous carbon. FIG. 12A is Raman spectrum; FIG. 12B is XRD patterns (PDF card for paraffin: 00-040-1995); and FIG. 12C is a TEM image.

FIGS. 13A-13C shows characterizations of flashed diamond. FIG. 13A is Raman spectrum; FIG. 13B is XRD patterns (PDF card for graphite: 00-056-0159); and FIG. 13C is a TEM image.

FIGS. 14A-14D shows characterizations of flashed SiC. FIG. 14A is Raman spectrum; FIG. 14B is XRD patterns (PDF card for graphite: 00-056-0159); FIG. 14C is Si is XPS patterns; and FIG. 14D is a TEM image.

FIG. 15 shows a schematic of a flash Joule heating vessel connected to gas capture vessel.

FIG. 16 shows a gas vessel used in flash Joule heating of liquid reactants.

FIG. 17 shows GC-MS data of gases trapped from the flash Joule heating reactions of both olive oil and crude oil.

FIGS. 18A-18D show mass spectra of fragments resulting from the FJH of various polymers (polypropylene, polystyrene, and PET) showing that fragments of the parent polymer can be observed.

FIG. 19 shows thermodynamic calculations (HSC Chemistry, Version 9) studying the catalyst-free reaction pathway of a polyethylene adduct as a function of reaction temperature.

FIG. 20 shows a diagram showing a believed mechanism for the formation of graphene and H₂ from HDPE.

FIG. 21A-21D show atomistic simulations of the FJH reaction including: (a) FIG. 21A shows a simplified representation of the atomistic model of an HDPE particle showing predominantly carbon spines of polymers where colors indicate individual polymer strands; FIG. 21B shows an individual polymer strand in full atomistic details as extracted from FIG. 21A: FIG. 21C shows H₂ production during the simulation at 1,500 K and 3.000 K; and FIG. 21F shows formation of aromatic networks at the early stages of HDPE deconstruction.

FIGS. 22A-22B shows the FJH conversion of asphaltenes to H₂ and graphene demonstrating high yield, efficiency, and purity of gas stream as well as high quality graphene. This sample was heated at 6 ohms.

FIGS. 23A-23D shows life-cycle assessment and technoeconomic analysis of FJH deconstruction, as compared to recent literature. FIGS. 23A-23C show the (a) cumulative energy demand, (b) greenhouse gas emissions, and (c) estimated production cost resulting from the production of 1 kg H₂ using different methods. FIG. 23D shows a comparison of different methods which produce H₂ from waste plastic, biomass, or hydrocarbons. The numbers refer to the designated references.

### DETAILED DESCRIPTION

The present invention relates to methods and systems for the synthesis of hydrogen gas by flash Joule heating, such as synthesizing hydrogen gas from waste plastic materials, other solid materials, or liquid materials by flash Joule heating.

In embodiments, the flash Joule heating (FJH) method synthesizes hydrogen from waste plastics (or other household, industrial or related cellulosic waste including wood, paper, and cardboard). Without any additional consumption of catalyst and solvents, hydrogen can be effectively synthesized with high purities (>90 vol %) and high yield (20-60%) within seconds. By modulating precursors types and flash parameters, the value-added materials, such as graphene, amorphous carbon, carbon nanotube and silicon carbide, can be simultaneously synthesized, which provides a secondary value stream to enhance the economic competitiveness of the H₂ (here can be called hydrogen or dihydrogen) production.

Hence, if this is viewed as a H₂ production process, then high purity turbostratic graphene is afforded as a value-added byproduct. The scalable process forms no stoichiometric CO₂ when deconstructing polyolefins and produces H₂ in purities up to 93.8% and yielding up to 46.6 mmol of H₂ g⁴ of polymer processed. That is equivalent to 65% of the available hydrogen atoms on the plastic being evolved as H₂.

### H₂ Synthesis

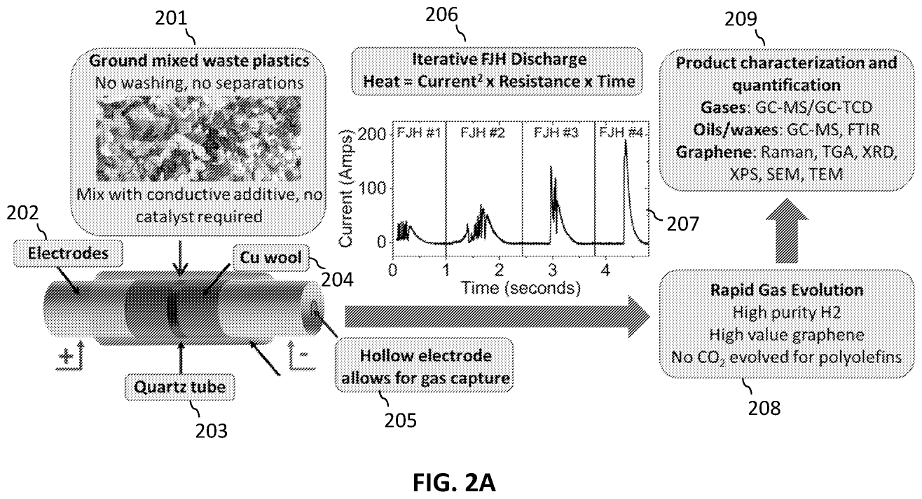

These methods and systems directly convert plastics, either virgin or postconsumer, (or solid materials, or liquid materials) into high purity H₂ gas and high-value graphene within seconds using a simple one-step process. The process requires no catalyst, no solvents, no water, and does not require the use of fossil fuels since waste materials are used as feedstocks (although fossil fuels, solids like coal or coke, or liquids like oils, can be used as the feedstock). FJH, a highly scalable technique, requires only the addition of a conductive additive if the feedstock is too low in conductivity. [Luong 2020; Wyss I 2022]. In some cases, such as anthracite coal, metallurgical coke of calcined coke, they are sufficiently conductive and no conductive additive is needed. A schematic showing the method that can be utilized is shown in FIG. 2A.

As shown in FIG. 2A, ground mixed waste plastics 201 (that do not need to be washed or separated) mixed with a conductive additive (with no required catalyst) are used in an FJH process. The FJH apparatus can include, for example, electrodes 202, quartz tube 203, copper wool 204, and have a hollow electrode 205 that allows for gas capture. The interative FJH discharge was performed (206). Graph 207 in the inset of FIG. 2A shows current discharge that can be utilized as a function of time over four iterative FJH treatments of a 6Ω initial resistance sample to deconstruct the polymer. This resulted in rapid gas evolution occurring (208) with high purity H₂, and high value graphene. No CO₂ was evolved for polyolefins such as polyethylene (PE) of polypropylene (PP). Product characterizations were performed for characterization and quantification (209) and are discussed below.

Examples. Representative examples of the catalyst-free deconstruction of waste plastic into H₂ and high-value graphene were performed as follows:

Preparation of reaction precursors are mixed through grinding with mortar and pestle, hammer milling, or ball milling. The reaction precursors include (1) the plastic, either virgin or postconsumer, ground and filtered through a 2 mm sieve and used without the need for any rinsing or pretreatment, and (2) a small amount of conductive additive which may include graphite, graphene, metcoke, carbon black, etc. As demonstrated in FIG. 2B (with traces 211-212 for sample resistance and temperature reached, respectively) the amount of conductive additive (in that plot it is Carbon Black BP-2000, Cabot), determines the initial resistance of the sample which impacts the temperature of the FJH reaction. When other conductive additives, such as pyrolysis ash, metallurgical coke also called “metcoke”, calcined coke, or charcoal are used, larger wt % of conductive additive may be required to reach an equivalent resistance. Once the reaction precursors are mixed thoroughly, resulting in a black/gray powder mixture can undergo the flash Joule heating process.

Flash Joule heating the mixture of precursors is shown in FIG. 2A, the mixture (0.5 g total, 0.08 g conductive additive Carbon Black BP-2000 from Cabot and 0.42 g polymer) is loaded into a quartz tube and compressed to have a resistance of 5-10 Ohm. Two copper or graphite rods were applied on both sides to act as electrodes. A hollow electrode was used to allow for the release and capture of volatiles into a Pyrex Schlenk flask that has been flushed with Ar and evacuated to −28 kPa. The entire system was leak-tight, holding the vacuum for at least ~15 mn after the valve to the vacuum established.

Then, flash Joule heating occurred, by charging a capacitor bank (220 mF) to 100-130 V. This was then discharged through the sample at very fast rates (typically less than 3 seconds) either using complete discharge, or a variable frequency drive (VFD) type discharge pulse. This process was repeated 3-4 times, until a singular sharp current discharge pulse is observed (graph 207 shown in FIG. 2A) and no more gas is evolved, as judged by a pressure gauge attached to the volatile trap. The interruptions in current discharge in the first 3 pulses were a result of volatiles leaving the system, temporarily increasing the resistance of the sample, thus lowering the amount of current able to pass through the sample. A pressure gauge attached to the volatile trap was used to measure the amount of volatiles evolved. Gas chromatography with a thermal conductivity detector (GC-TCD) was then used to measure the partial pressure of H₂ in the mixture, which can then be used to determine the amount of H₂ evolved by the process, using the ideal gas equation and the experimentally determined pressure, temperature, and volume of evolved gases. GC-TCD can also detect methane and CO, if present. Syringe headspace sampling of the volatile trap was also analyzed by GC-MS, which detected the small hydrocarbons produced (up to C₆ species). The volatile trap can also be rinsed with a variety of solvents to study oil, wax, or aromatic species by injecting this rinse into the GC-MS. Standard analyte mixtures (of gases, oils, and aromatics) allow for the quantification of substances produced by the FJH deconstruction of plastics.

This powder, graphene, can be removed from the quartz tube, weighed, and characterized. Typically, Raman spectroscopy, powder X-ray diffraction, thermogravimetric analysis, X-ray photoelectron spectroscopy, and scanning electron microscopy were used to characterize the graphene products for purity and quality, as discussed below.

Further Examples: Further representative examples of hydrogen generation from plastic by flash Joule heating (FJH) process were performed as follows:

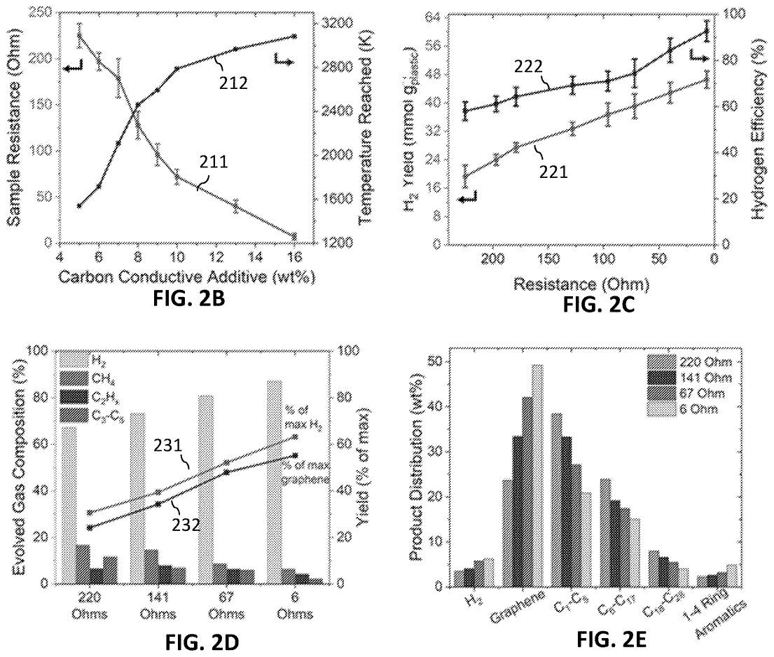

Sample preparation. Different waste plastic precursors, including high-density polyethylene (HDPE), polypropylene (PP), polystyrene (PS), polyvinylidene fluoride (PVDF) and glass fiber reinforced plastic (GFRP) were grinded by a hamper grinder (Wenling LINDA machinery Corporation, DF-15). The C and H contents in each precursor were quantified by the elemental using an ECS 4010—CHNS-O Elemental Combustion System. FIG. 3. The grinded GFRP samples were further milled by a planetary ball milling (MSE Supplies, PMV1-0.4 L) for 2 hours. For carbon nanotube (CNT) synthesis, 3.0 mg of ferric chloride (FeCl₃, 97%, Millipore-Sigma) was dissolved into 30 mL solvent consisted of 80/20 v/v mixture of water (Millipore-Sigma, ACS reagent for ultratrace analysis) and ethanol (Millipore-Sigma, ACS reagent, >99.5%). Afterwards, 5.0 g of HDPE was dispersed into the FeCl₃ solution in an ultrasonic bath (Cole-Parmer Ultrasonic Cleaner) for 15 min. The sample was then vacuum dried in a desiccator overnight to remove the solvent, which was denoted as Fe-loaded HDPE.

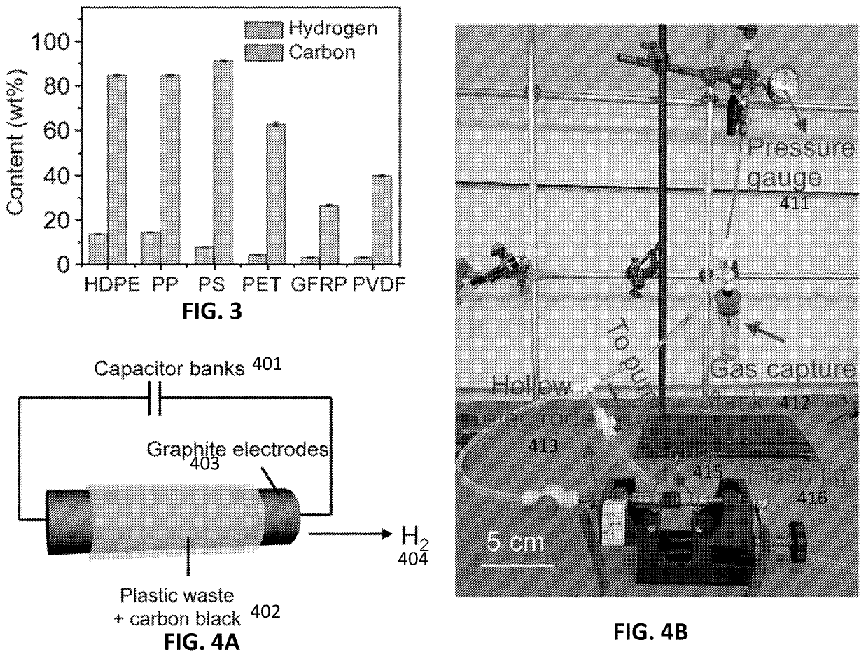

Hydrogen generation from plastic by flash Joule heating (FJH) process. A schematic of an FJH process and the photo of the FJH devices for hydrogen generation and collection are shown in FIGS. 4A-4B. FIG. 4A shows capacitor bank 403 that are used for the FJH provide to the quartz tube having graphene electrodes 403 and a mixture of plastic waste and carbon black 402 (with the carbon black being the conductive additive) used to synthesize the hydrogen gas 404. The graphite electrodes 403 are loaded into the quartz tube, and two brass electrodes with O-rings 415 of the flash jig 416 are used to seal the samples inside the tube. The evolved gas could flow through hollow electrode 413 into gas capture flask 412.

During the FJH process, the treated plastic samples was premixed with carbon black (Cabot, Black Pearls 2000) with the mass ratio of 4:1 and then hand-milled for 5 minutes. Then, the mixture was loaded into a quartz tube with inner diameter (ID) of 8 mm and outer diameter (OD) of 12 mm. The two brass electrodes with O-rings were applied to compress and seal the sample. A spring wound on the surface of the tube was used to increase the mechanical integrity of the tube and avoid the accumulated pressure induced break during the FJH process. (The spring was wound around the tube surface and was used to prevent explosion caused by the gas generation during the FJH process). The system was purged with Ar to +75 kPa, then evacuated to −95 kPa for 5 times prior to FJH reaction to remove the residual air the system. The capacitor bank 403 was charged by a direct current (DC) supply.

The FJH input capacity can be modulated from 60 to 114 mF by tuming on different amounts of capacitors. The maximal voltage of the capacitor bank can reach 400 V. The relay with programmable delay time with millisecond controllability was applied to control the discharging time. Experimental details are listed in TABLE I. During the FJH, the evolved gas can vent from the quartz reaction tube through a hollow electrode 413 into a sealed gas collection flask 412 with a volume of 280 mL. A pressure gauge 411 attached to the flask was used to measure the amounts of evolved volatiles.

TABLE I
Parameters for FJH

| | | Loading | | | | | Pres |
|---|---|---|---|---|---|---|---|
| | Target | Mass | Res | Cap | Volt | Time | Change |
| Precursors* | Prod | (mg) | (Ω) | (mF) | (V) | (s)** | (kPa) |
| HDPE:CB = 4:1 | Graphene | 500 | 20 | 114 | 100 V, 1 time | 5 | 328 |
| | | | | | 110 V, 1 time | | |
| | | | | | 120 V, 1 time | | |
| Fe loaded | CNT | 300 | 3 | 114 | 120 V, 2 times | 5 | 193 |
| HDPE:CB-4:1 | | | | | 100 V, 3 times | | |
| 0.1 wt % Fe | CNT | 300 | 20 | 114 | 160 V, 1 time | 5 | 131 |
| (FeCl3) loaded | | | | | 100 V, 1 time | | |
| HDPE:CB = 4:1 | | | | | | | |
| 1 wt % Fe | CNT | 300 | 20 | 114 | 160 V, 1 time | 5 | 136 |
| (FeCl3) loaded | | | | | 100 V, 1 time | | |
| HDPE:CB = 4:1 | | | | | | | |
| 1 wt % Fe | CNT | 300 | 15 | 114 | 160 V, 1 time | 5 | 127 |
| (Ferrocene) | | | | | 100 V, 1 time | | |
| loaded | | | | | | | |
| HDPE:CB = 4:1 | | | | | | | |
| 0.5 wt % Fe | CNT | 300 | 13 | 114 | 160 V, 1 time | 5 | 115 |
| (FeCl3)/0.5 | | | | | 100 V, 1 time | | |
| wt % Ni | | | | | | | |
| (NiCl2) loaded | | | | | | | |
| HDPE:CB = 4:1 | | | | | | | |
| HDPE:CB = 4:1 | Amorphous | 500 | 20 | 72 | 80 V, 1 time | 5 | 238 |
| | carbon | | | | 90 V, 1 time | | |
| | | | | | 100 V, 2 times | | |
| PVDF:CB:NaF = | Nano- | 300 | 8 | 60 | 120 V. 2 times | 5 | 193 |
| 7:2:1 | diamond | | | | | | |
| GFRP:CB = 4:1 | SiC + | 500 | 10 | 114 | 100 V, 1 time | 5 | 147 |
| | Graphene | | | | 110 V, 1 time | | |
| | | | | | 120 V, 1 time | | |

Note:
*The ratios of precursors here are mass ratios.
**The flash time was set as 5 s to ensure the complete discharging.

Controls. Parameters and other factors can be used for FJH evolution of H₂ from waste plastics (and other materials) and can include the followving:
(i) The initial resistance of the precursor plastic/additive mixture can be used to control the overall reaction temperature reached. The initial resistance can be controlled by varying the amount of conductive additive (FIG. 2B, with traces 211-212 for sample resistance and temperature reached, respectively). Polyethylene was used as a model system. More H₂ is produced, and in greater purities, when the resistance is lower, resulting in higher reaction temperatures (FIG. 2C, with traces 221-222 for H₂ yield and hydrogen efficiency, respectively). Greater hydrogen efficiency, defined here as the total mass of atomic hydrogen contained in all gas phase products, as compared to the atomic hydrogen content of starting polymer, also increases as initial resistance decreases (FIG. 2C). Hotter, faster heating rates result in more H₂ recovered and more atomic hydrogen liberated from solid polymer (FIG. 2C), up to 46.6 mmol H₂ g⁻¹ of plastic, and 92.7% efficiency, when initial sample resistance of 6 ohms and high density polyethylene (HDPE) feedstocks are used.

(ii) Other gases can be produced, predominantly consisting of methane and short alkenes. However, as the reaction kinetics are accelerated and higher temperatures are reached, the purity of H₂ increases (FIG. 2D, bar graph). In an ideal system, all carbon atoms in the polyethylene would convert to graphene, while all hydrogen atoms would be released as H₂, resulting in a 100% yield compared to the theoretical maximum. The percent yield versus this ideal maximum is also plotted in FIG. 2D (line graph, with traces 231-232 for evolved gas composition and yield, respectively). A complete mass balance can be used to understand what other products are produced during the deconstruction process, and how this is impacted by reaction kinetics. FIG. 2E shows the mass yield of H₂, graphene, other gases, liquids, solids, and aromatic residues produced by the FJH deconstruction. Like FIG. 2D, faster and hotter reactions favor more complete polymer deconstruction, resulting in fewer oils and waxes and more graphene and H₂ being recovered at lower sample resistances.

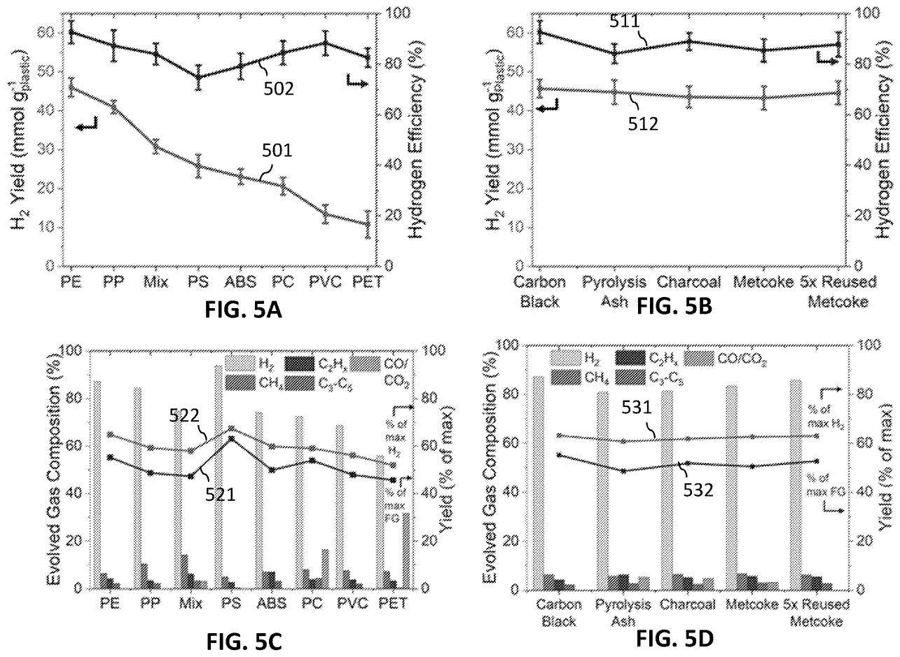

(iii) Virgin or postconsumer polymers (so far demonstrated polyvinyl chloride (PVC), high-density polyethylene (HDPE), polyethylene terephthalate (PET), polypropylene (PP), polystyrene (PS), acrylonitrile butadiene styrene (ABS), and low-density polyethylene (LDPE)) can be converted into flash graphene with high recovery yields of H₂ (FIG. 5A, with plots 501-502 for H₂ yield and hydrogen efficiency, respectively; FIG. 5B with plots 511-512 for evolved gas composition and yield, respectively). The purity of H₂ resulting from all polyolefins is >84%. Some CO and CO₂ was produced when polyesters were deconstructed, resulting from the oxygen present in the ester linkages. Similarly, some N₂ was produced when ABS is deconstructed. As these polymers contain less atomic hydrogen, smaller amounts of H₂ are recovered, but overall efficiency and yields remain high (FIGS. 5A-5B). The yield of H₂ and graphene is somewhat impacted by polymer identity, at 52-68% yields for H₂, and 46-63% yields for graphene, outperforming other catalyst-free deconstruction methods by 5-10×.

(iv) The process was performed using carbon black as the conductive additive, but the process can also accommodate low-value carbon materials such as charcoal, metallurgical coke (metcoke), plastic pyrolysis ash, scrap-tire carbon black, biochar, and calcined coke. Conductive additives (metallurgical coke) can be reused by simple sieving for many iterations, further reducing cost burden associated with the required conductive additive (FIG. 5C, with traces 521-522 for H₂ yield and hydrogen efficiency, respectively; FIG. 5D with traces 531-532 for evolved gas composition and yield, respectively.) Small amounts of CO/CO₂ were produced when the conductive additive has atomic O content. Metcoke can be iteratively used as a conductive additive through simple sieve separation, further lowering costs associated with the conductive additive, with 91.7% recovered after 5 use cycles. Further, after the first cycle, no CO or CO₂ is produced since the O content has been removed from the metcoke additive.

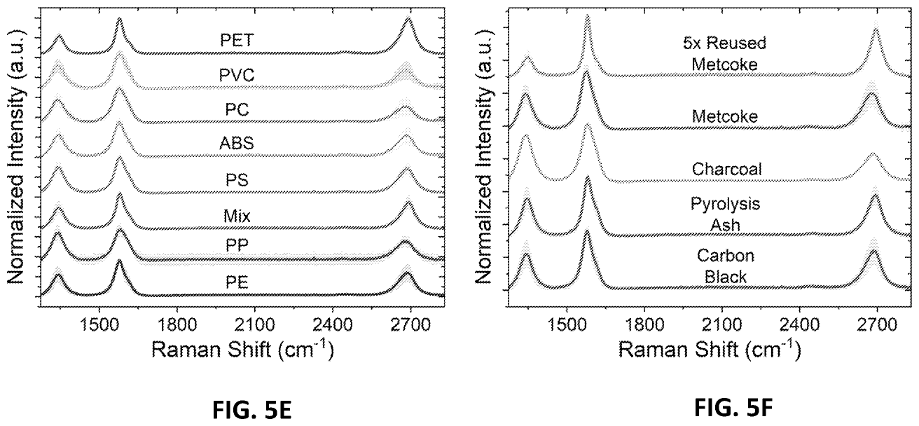

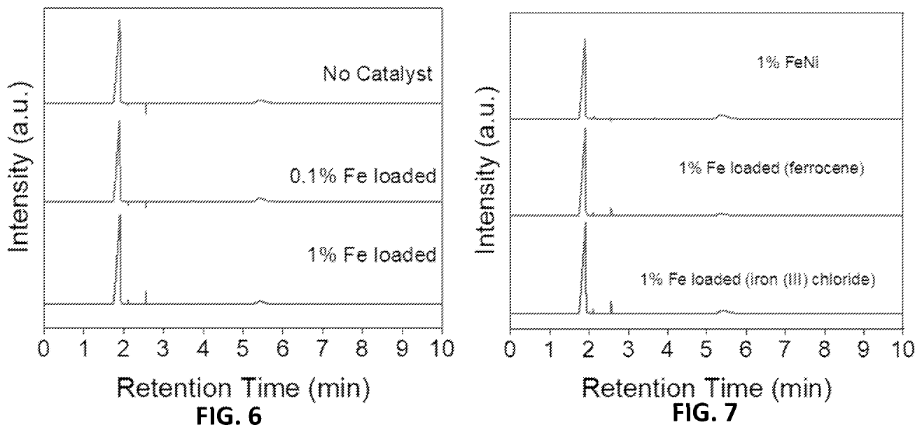

Catalyst selection for H₂ and CNT synthesis. While a catalyst is not required for FJH evolution of H₂ from waste plastics (and other materials), catalysts can be utilized. The type and contents of Fe-containing catalyst for the hydrogen generation. First, when using iron chloride as the catalyst, the H₂ yield increased from 29% to 46% (FIG. 6), with the increase of Fe loading content from 0 to 1 wt %. Also, changes were made to the catalysts from FeCh to ferrocene and the mixture of FeCl₃/NiCl₂, where the metal contents were kept as 1 wt % (FIG. 7). It was found that all of these catalysts can effectively facilitate the H₂ generations. The same catalysts can be added to the deconstruction of glass/plastic or carbon fiber/glass to afford silicon carbide nanofibers and nanotubes.

### Hydrogen Detection

Hydrogen detection was performed on the evolved gas by gas chromatography-thermal conductivity detector (GC-TCD). The partial pressure of H₂ in the mixture were quantitatively analyzed using an Agilent 8890 GC with 5977 B MSD and G4407 TCD equipped with an AgilentHP-5 ms low-bleed column (30 m. 0.25 mm internal diameter, 0.25 μm film). Ar was used as the carrier gas of for the TCD test. The amount of H₂ evolved by the FJH process can be calculated using the ideal gas equation and the experimentally determined pressure, temperature, and volume of evolved gases according to Equation 1. A series of high-purity mixture gas with different hydrogen/argon ratio were tested by GC-TCD to get the calibration curve between the peak integration and hydrogen concentrations.

$$n = \frac{r Δ PV}{RT} = \frac{kI Δ PV}{RT} \qquad ( 1 )$$

where n is the mole amount of evolved hydrogen; ΔP is the pressure change before and after FJH; V is the volume of gas collection flask, which is 280 mL in our experiment: T is the temperature, R is molar gas constant, which is 8.314, r is the hydrogen volume ratio in the evolved gas, which can be calculated by multiplying the hydrogen peak intensity (I) and the slope of the calibration curve (k).

The H₂ yield (y) can be further calculated according to Equation (2):

$$y = \frac{nM ( {H}_{2} )}{x m} \qquad ( 2 )$$

where M(H₂) is the molar mass of H₂, in is loaded plastic mass per batch, x is the mass ratio of hydrogen in plastic. For HDPE, x was calculated to be 0.14. For GFRP, the plastic was mostly epoxy or phenol formaldehyde resins, where x is ~0.06. [Sathishkumar 2014].

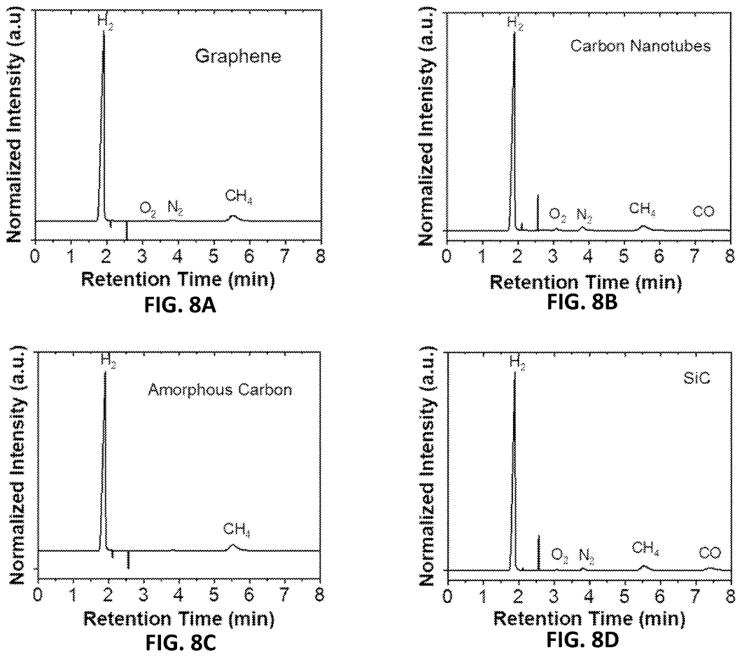

The representative GC-TCD spectra were shown in FIGS. 8A-8D for the graphene, carbon nanotube (CNT), amorphous carbon and SiC synthesis, where the main peak with a retention time of ~1.8 min can be ascribed to H₂, and the small amounts of N₂ and O₂ may come from air. The H₂ purity in evolved gases are higher than 90 vol %. The H₂ yields were calculated to be 31.7%, 25.0%, 20.0%, 60.1% for graphene, carbon nanotube (CNT), amorphous carbon and SiC synthesis.

### Characterizations of Residual Materials

The graphene and other residual materials were characterized.

The graphene produced by the FJH processes was characterized by a host of techniques to demonstrate that it is a valuable co-product. Raman spectroscopy is the most common technique, as it can probe quality and purity of graphene. Purities of 96-100% were common for optimized conditions, and high quality turbostratic graphene was spectroscopically observed for all plastics and conductive additives studied (FIGS. 5E-5F).

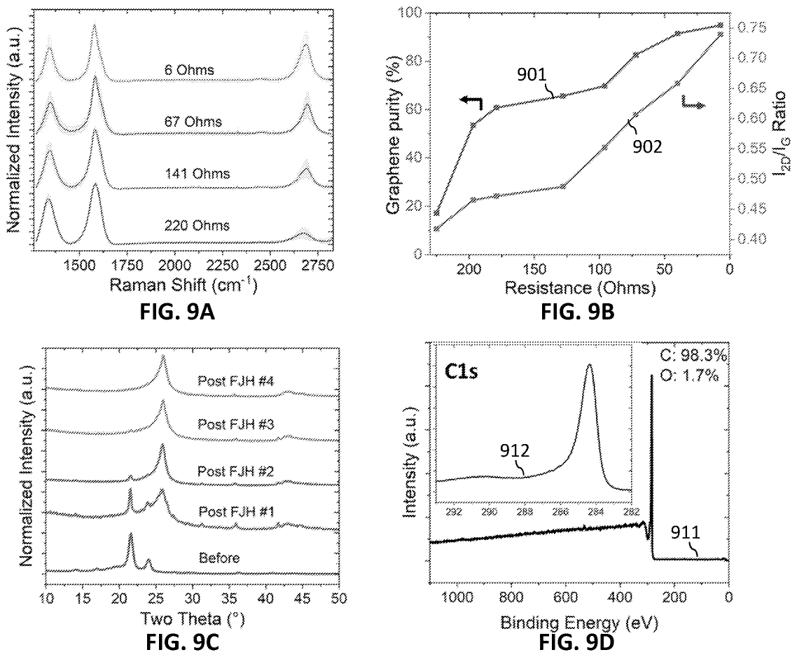

Further graphene characterization of polyethylene derived graphene produced by the methods described herein is seen in FIGS. 9A-9F, including a demonstration of dispersibility, which can be one of the most important aspects of graphene that will be used in composite applications.

FIG. 9A shows the average Raman spectrum (100 unique spectra, over a 1 mm² area) of graphene produced as initial polyethylene sample resistance is varied. FIG. 9B is Raman spectroscopy determined graphene purity (trace 901) and I_{2D}/I_{G} ratio (trace 902) as a function of sample resistance. FIG. 9C shows bulk powder X-Ray diffraction analysis of solid produced from a 6Ω sample of polyethylene over iterative FJH treatment, as compared to the initial feedstock mixture, showing bulk conversion of polyethylene into pure graphene. FIG. 9D shows X-Ray photoelectron spectroscopy analysis of a 6Ω sample produced graphene (plot 911), with inset high-resolution analysis of the C1s transition (plot 912). FIG. 9E shows scanning electron micrograph (SEM) of crystalline graphene produced from a 6Ω sample of polyethylene. FIG. 9F shows high resolution Raman spectra demonstrating the presence of the TS1 and TS2 peaks in FJH graphene samples (plot 921) indicating turbostratic stacking, while the presence of the M peak in commercial graphene samples (plot 922) indicating AB stacking. An inset photograph shows polyethylene-derived graphene 924 and commercial graphene 923 dispersed in water-Pluronic (F-127) solution (1 wt %) by sonication and centrifuged, showing turbostratic stacking significantly improves graphene dispersibility.

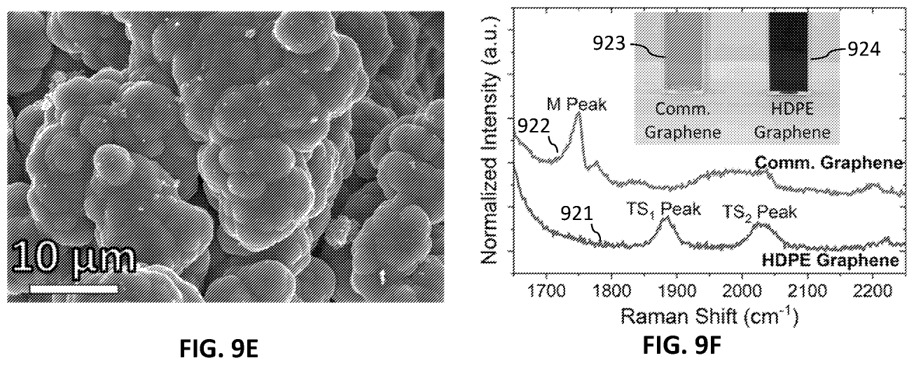

Further, Raman spectra were acquired using the Renishaw Raman microscope system with the laser wavelength of 532 nm, laser power of 5 mW and lens of 50×. A distinct 2D peaks as well as a low D peak in the Raman spectrum revealed the formation of graphene during FJH (FIG. 10A). Further high-resolution Raman spectrum also showed a TS1 and TS2 peaks (FIG. 10B), indicating the turbostratic structure of flash graphene. [Luong 2020]. Its graphitic structure was further confirmed by X-ray diffraction (XRD) patterns (FIG. 10C), which was performed using the Rigaku SmartLab system with a filtered Cu Ku radiation (λ=1.5406 Å). The TEM images were obtained on a JEOL 2100 field emission gun transmission electron microscope at 200 kV.

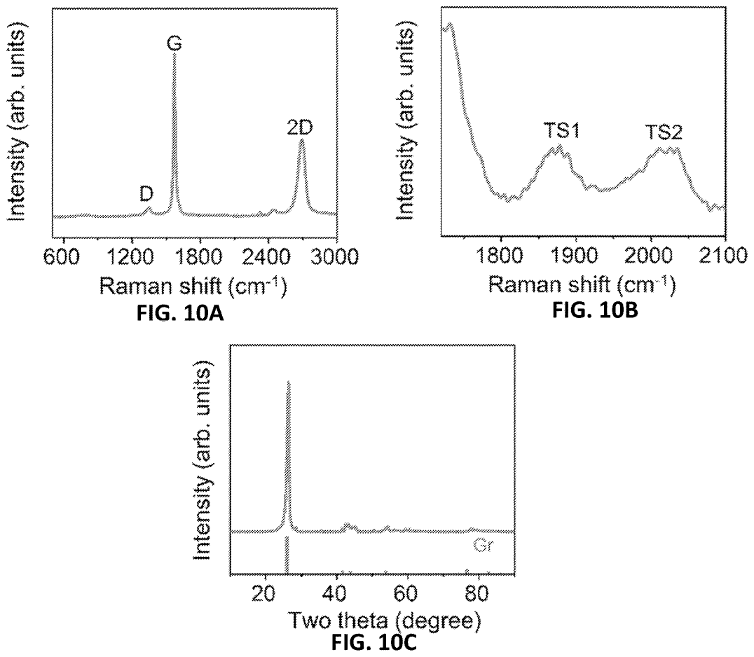

For the CNT, its nanotube structure was observed by SEM and TEM with an average diameter of tens of nanometers (FIGS. 11A-11B), which were taken on the FEI Quanta 400 ESEM FEG system under the voltage of 20 kV and the working distance of 10 mm. X-ray photoelectron spectrum revealed the presence of catalytic iron and carbon with a low oxygen content (<3 at %, FIG. 11C), indicating high purities of the CNT samples. XPS spectra were taken by the PHI Quantera XPS system under a pressure of 5×10⁻⁹ Torr. The survey spectra were collected with the step of 0.5 eV and the pass energy of 140 eV, and elemental spectra were collected with the step size of 0.1 eV and the pass energy of 26 eV. All XPS spectra were calibrated using the C is peak at 284.8 eV as the reference. The Raman peaks in the range of 200-300 cm⁻¹ is related to radial breathing modes of CNT (FIG. 11D).

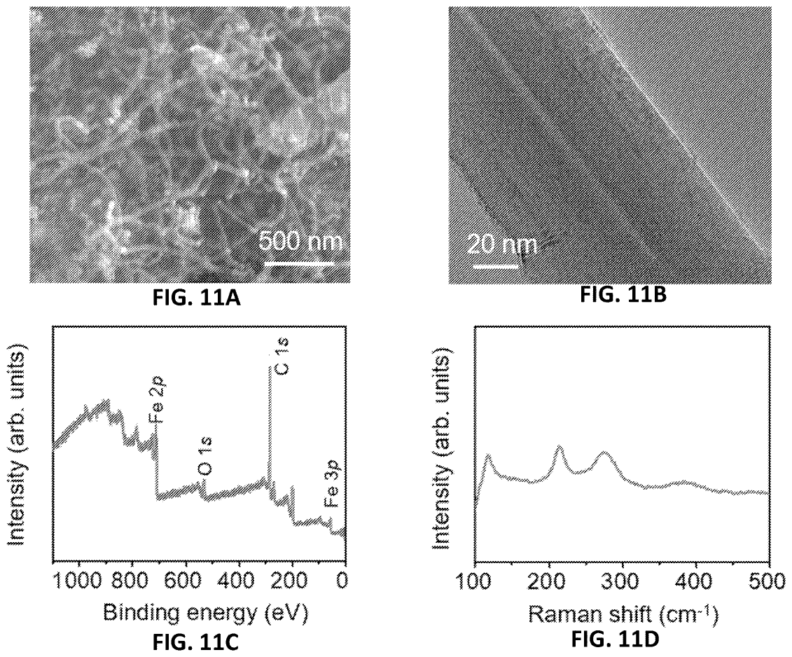

For the amorphous carbon sample, the overlapped D and G peaks in Raman spectrum indicated high defects (FIG. 12A). The broad peak at ~25° in XRD patterns (FIG. 12B) and amorphous structure in the TEM image (FIG. 12C) reveal its low crystallinity, while the paraffin signals may come from the HDPE degradation products.

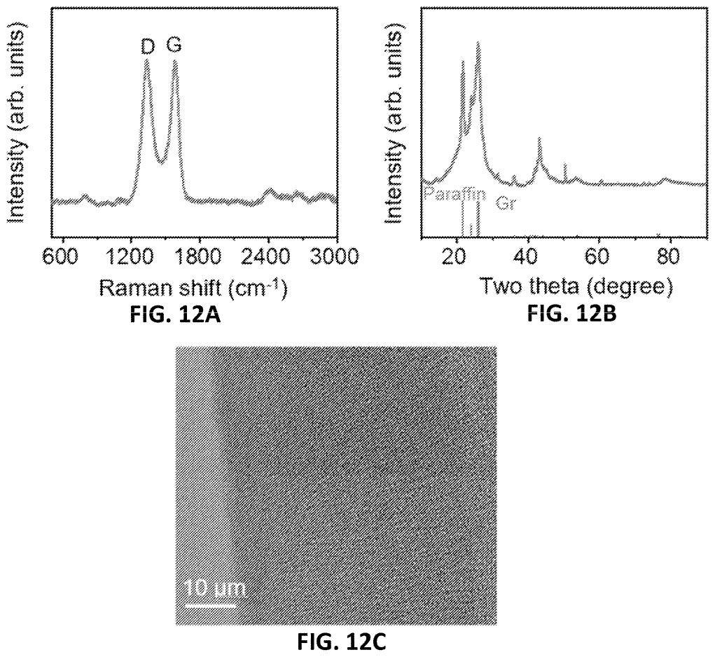

For the nanodiamond sample, the sharp peak at 1330 cm⁻¹ in Raman spectrum indicated its diamond structure (FIG. 13A), which are also confirmed by its XRD patterns (FIG. 13B) and the lattice structure in TEM image (FIG. 13C).

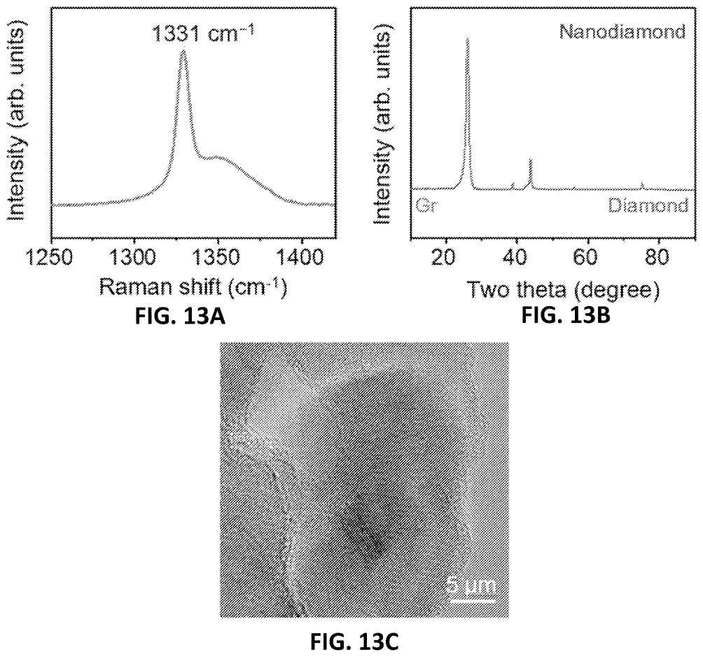

For SiC, Raman spectrum revealed the presence of graphene with D, G and 2D peaks and SiC with TO and LO peaks (FIG. 14A). XRD patterns further confirmed the co-existence of graphene and SiC (FIG. 14B) and TEM images revealed the lattice structure of SiC (FIG. 14C). Further XPS spectrum evinced that the Si—C is the main peak in its Si 2p XPS spectrum, while the Si—O peak may come from the slight oxidation on the SiC surface (FIG. 14D).

### Liquid Feedstock

In addition to the waste product and other solid materials that can be used for synthesizing hydrogen gas by flash Joule heating, liquid materials can be utilized. When the liquid feedstock has both carbon and hydrogen chemically present, such as in most oils, then the gaseous products of flashing are hydrogen gas and carbonaceous gases, such as butane or other alkanes. If the reaction is performed under an inert environment, such as under argon, then the reactive elements present will only be those from the flash Joule heating feedstock.

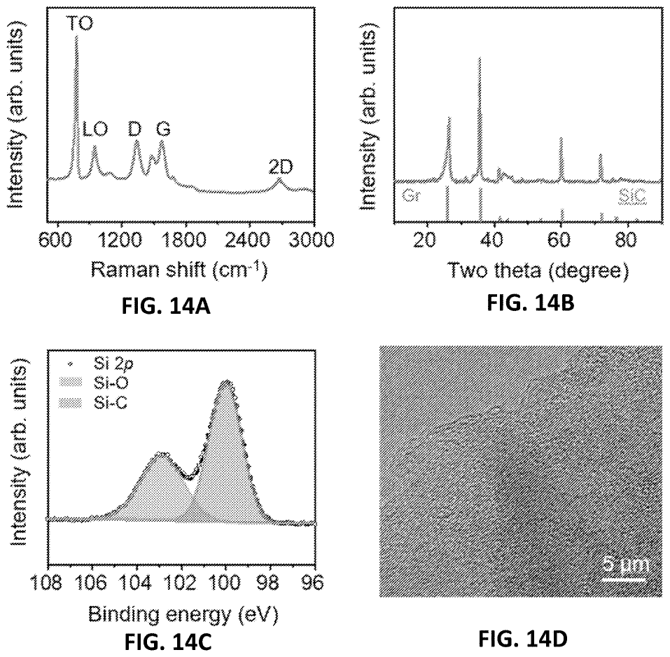

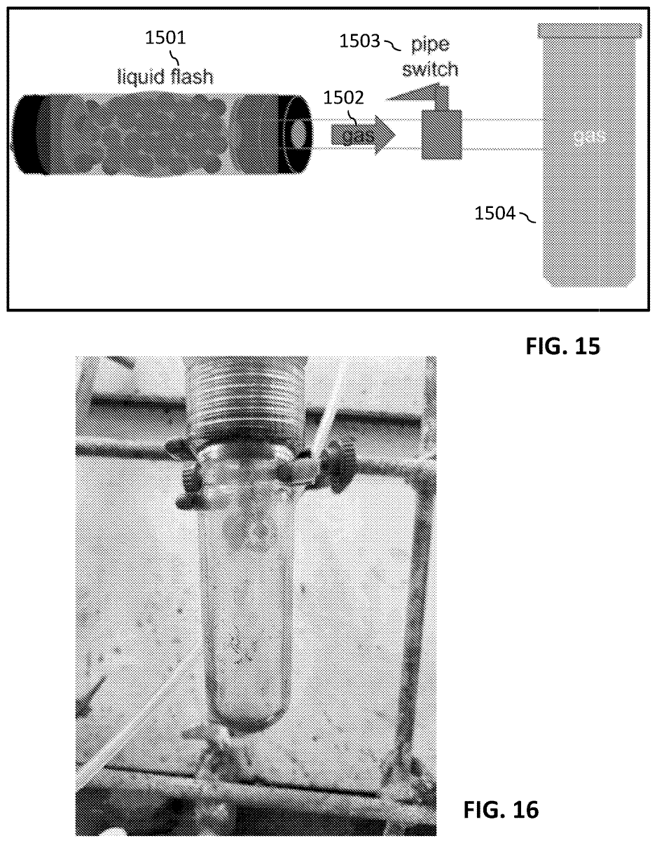

FIG. 15 shows a schematic of a flash Joule heating vessel 1501 (with the liquid feedstock absorbed on a sponge, such as a carbon-based sponge, carbohydrate-based sponge or a glass-based sponge) connected to gas capture vessel 1504. As the flash Joule heating process occurs, the gas 1502 escapes from the vessel 1501 and flows through pipe switch 1503 to be captured in capture vessel 1504. FIG. 16 shows a gas vessel used in flash Joule heating of liquid reactants.

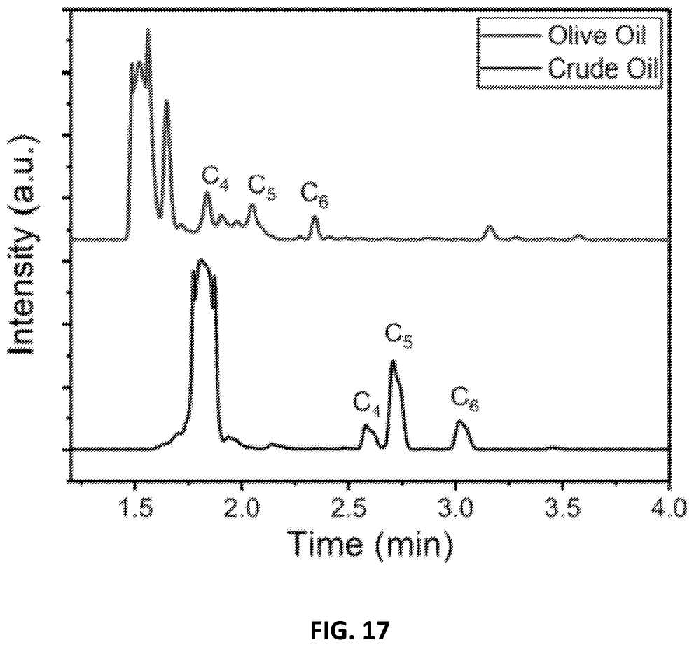

The gases trapped in the gas capture vessel are can include argon (from the inert flashing atmosphere if present) as well as hydrogen and any other gases formed during the flash Joule heating process. A composition of trapped gas was evaluated by an Agilent 8890 gas chromatography system with 5977 B MSD and G4407 TCD, the latter of which was used to measure the hydrogen gas concentration. A GC chromatograph of gases trapped from two liquid flashes (olive oil and crude oil) is shown in FIG. 17. The predominant products from these two reactions are carbonaceous gases comprised of 4-6 carbon atoms per gas molecule. The larger peak is H₂.

### Computational and Experimental Mechanistic Study of FJH Process

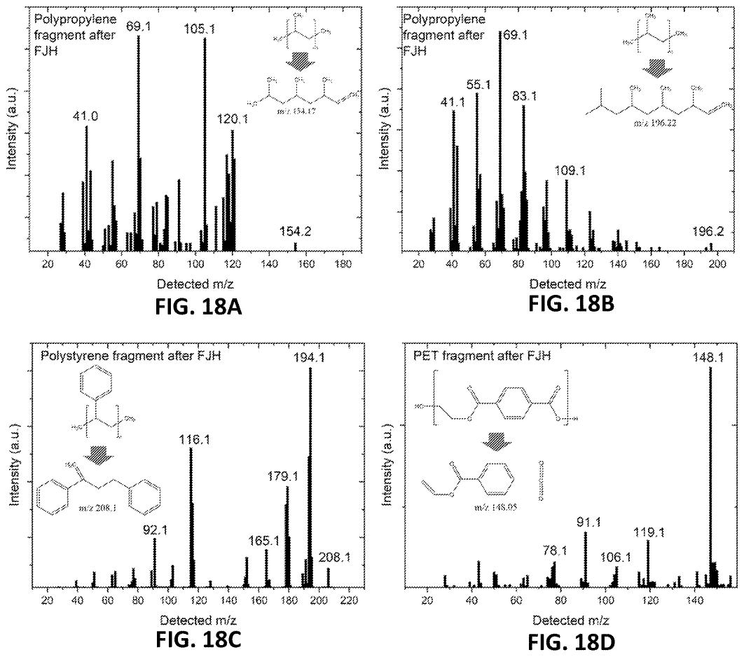

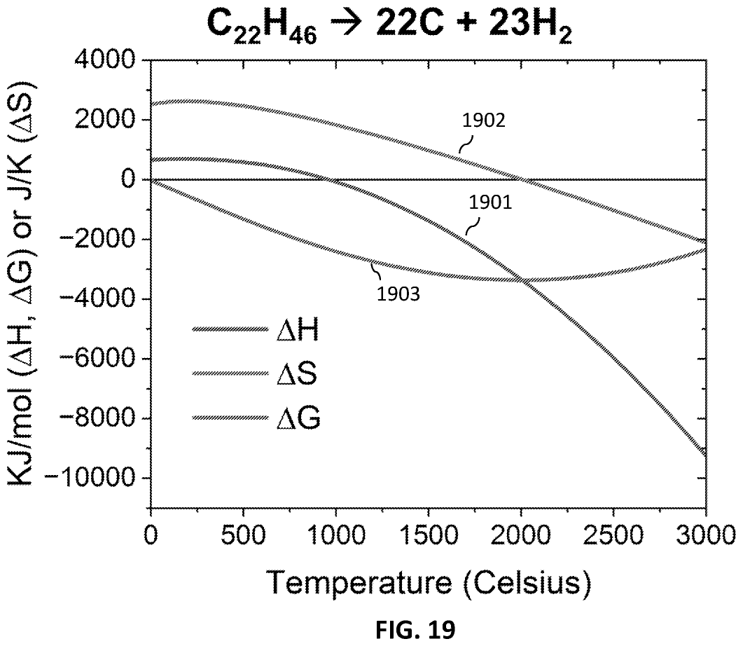

Since no catalyst need be present during the rapid FJH, the generation of flash H₂ is believed to proceed through C—H bond homolysis, which deconstructs the polymer chains into the observed volatiles (FIGS. 18A-18D). The ultrafast heating rates and high temperatures (FIG. 2B) allow for more complete deconstruction into the most thermodynamically favored products. FIG. 19 (with plots 1901-1903 for ΔH, ΔS, and ΔG, respectively). (Note that in FIG. 19, the enthalpy of reaction does not become negative until above 1,000 C. explaining why H₂ evolution was not observed during traditional low temperature, slow heating rate pyrolysis processes). The reaction mechanism for the FJH or laser vaporization-assisted transformation of amorphous or olefinic carbon into graphene has been previously attributed to mobile carbon nucleating the sheets through a seed-growth mechanism, which can achieve diffusion-controlled reaction kinetics at sufficiently high energy density. [Stanford 2020; Beckham 2022; Kokai 2022].

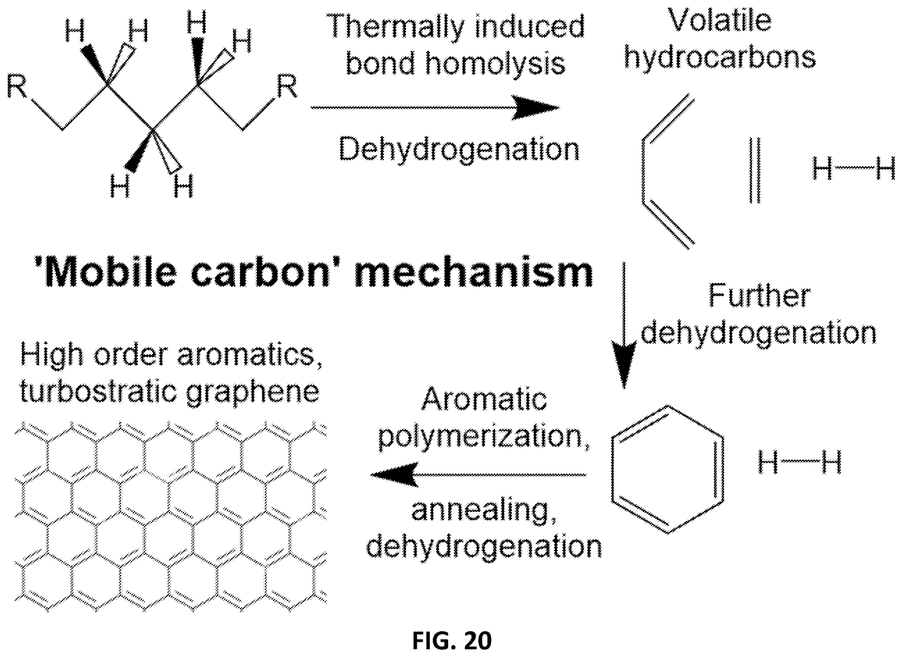

The growth of semicrystalline turbostratically stacked sheet-like graphene domains from small, wrinkled, and defective regions can be observed morphologically by SEM imaging as the sample resistance decreases. Large areas of sheet-like morphologies were not observed until reaching temperatures >2,300 K, corresponding to an atomic C vapor pressure of ~10⁻⁴ Pa. This low vapor pressure, maintained for only milliseconds, is unlikely to allow for micron scale crystal growth, indicating another intermediate is required for the mobile carbon hypothesis. [Lopes 2018]. The FJH process formed 1,3-butadiene, ethylene, and benzene as detected by GC-MS, which can combine through aromatic polymerization, forming graphitic domains. FIG. 20. Aromatic products were detected, with the overall amount and size of aromatics increasing as resistance is lowered and higher temperatures are achieved. Polymerization of polyaromatic hydrocarbons has been previously demonstrated under high energy density conditions, such as in stars or under laser irradiation. [Webster 2022: Contreras 2013]. The detected polyaromatic hydrocarbons formed during FJH can be considered the seeds of eventual turbostratic graphene sheets, which grow through aromatic coupling of other mobile carbon species.

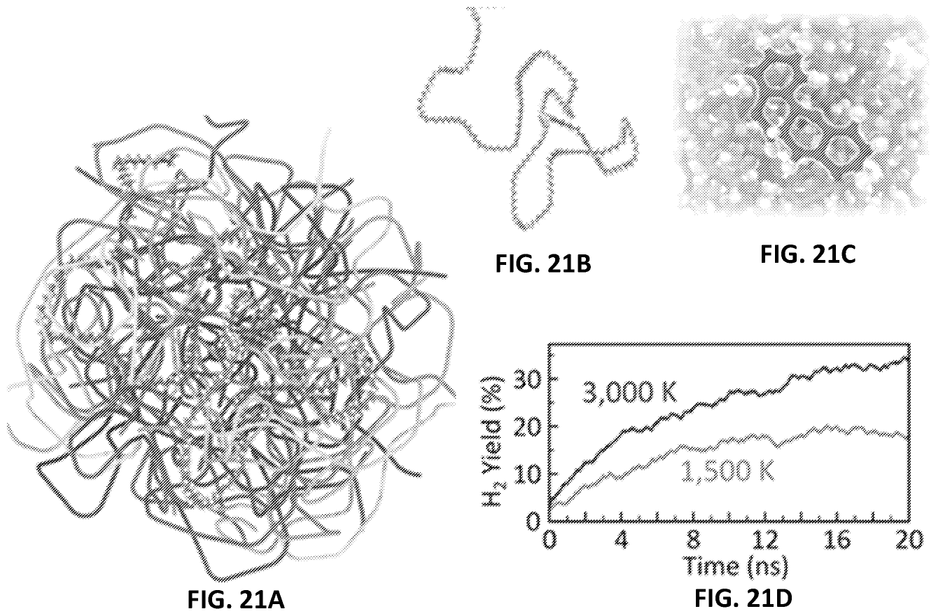

These findings were also analyzed computationally through molecular dynamics (MD) simulations with AIREBO interatomic potentials. [Stuart 2000: Brennar 2002]. Following the structural characteristics of the HDPE, the system of long, highly intertwined PE strands was constructed. [Miao 2001]. Due to the high flexibility of the polymer chains at temperatures observed during FJH, smaller structures or those containing shorter chains displayed rapid unraveling mandating the use of chains with at least 150 carbon atoms. [Bets 2009]. The HDPE structure was generated through the iterative addition of carbon strands composed of a series of randomly oriented straight and curved segments, ensuring a significantly interwoven configuration (FIG. 21A-21B). Following experimental results, the system behavior was compared at 1500 K and 3000 K, representing samples with high (225 Ohm) and lower (30 Ohm) resistance, respectively. In both cases, the evolution of H₂ was observed throughout the simulation, with H₂ production significantly increased at higher temperatures (FIG. 21C). The synthesis of short-chain hydrocarbons was also observed. The dehydrogenated and partially dehydrogenated carbon chains were observed to form bonds producing interconnected carbon networks and aromatic segments (FIG. 21D), further proceeding to the formation of graphitic domains.

### Uses And Applications

Hydrogen gas is the primary storable fuel for pollution-free energy production, with over 90 million tonnes consumption globally per year. Current H₂ synthesis methods, including methane reforming, methane pyrolysis and electrolysis, suffer from low efficiency, high energy consumption, high cost and high greenhouse gas emissions, while no value-added co-products were synthesized. Here, flash Joule heating (FJH) method to synthesize hydrogen from waste plastics, as well other solid materials and liquid materials. Without any consumption of catalyst and solvents. H₂ can be effectively synthesized with high purities (>60 vol %) and high yield (20-60%) within seconds. By modulating precursors types and flash parameters, the value-added materials, such as graphene, amorphous carbon, carbon nanotube and SiC in the form of particles or 1-dimensional fibrals or tubes, can be selectively synthesized at the same time, which provides a secondary value stream to improve the economic competitiveness of flash H₂ production.

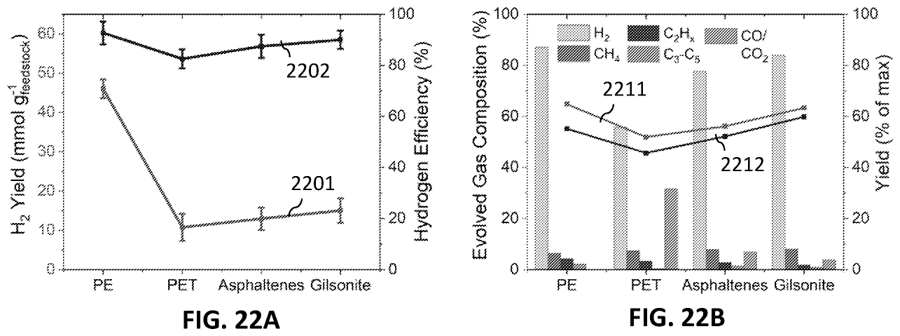

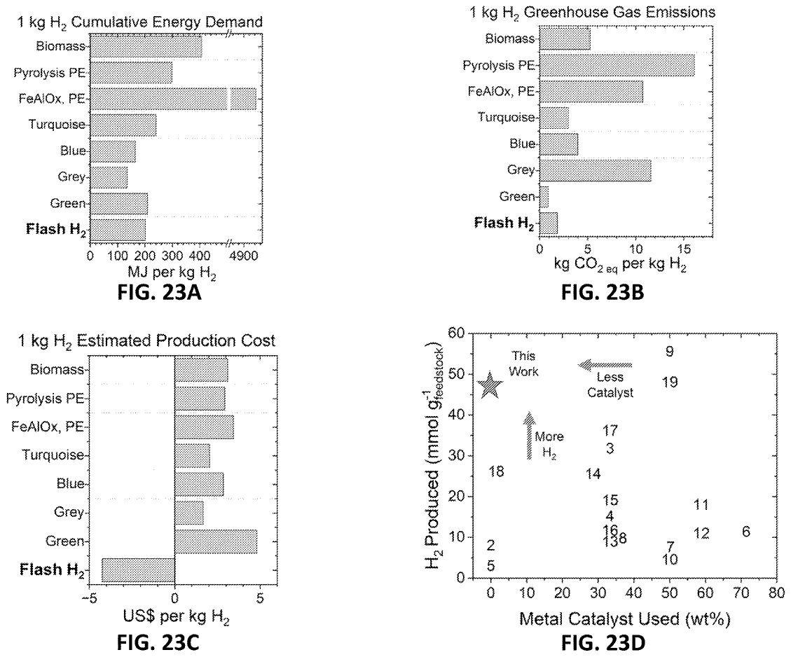

For the upcycling waste plastic into hydrogen and other materials by flash Joule heating (FJH) method, the applications include:
(i) Waste plastic can be converted into hydrogen gas by FJH with high purity (>90 vol %), which can be further used as the energy source for fuel cells.
(ii) Different types of materials, including graphene, carbon nanotube, amorphous carbon, graphite (through extended heating of the graphene) and SiC can be simultaneously synthesized by modulating precursor types and flash parameters. Graphene formed by the FJH method has been leveraged in many demonstrated applications, including composites, energy storage in Li batteries, and electrocatalysis. [Wyss III 2022: Wyss 2021]. In ~3 years, FJH production of graphene has increased from I g per hour to >1 kg per hour rates at laboratory scale, while industry has achieved pilot plant tonne-per-day rates. Feedstocks besides waste plastics should also be considered, ideally high in atomic H content and low in atomic O content to minimize CO₂ evolution. Asphalt, bitumen, and asphaltenes contain >11% H and <1% O, and they present large-scale, low-cost materials that can supplement plastic deconstruction for H₂ production if necessary. [Petersen 2000]. Asphaltenes and Gilsonite are demonstrated here to also produce high purity H₂ and graphene byproduct. FIG. 22A (with plots 2201-2202 for H₂ yield and hydrogen efficiency, respectively): FIG. 22B (with plots 2211-2212 for evolved gas composition and yield, respectively).
(iii) FJH is time- and energy-saving, and generates low amounts of greenhouse gases, compared with other hydrogen synthesizing methods, such as steam methane reforming and methane pyrolysis. FIGS. 23A-23D.

H₂ demand is projected to significantly increase as its use as a fuel-cell and combustion fuel source increases, as the transportation sector searches for green fuel alternatives. Production methods that do not evolve large amounts of carbon dioxide are essential. No CO₂ is produced when polyolefins undergo FJH. If renewable energy sources are used to power the FJH system, then no stoichiometric amounts of CO₂ will result from the production of H₂ from these plastics.

The methods and systems described herein are much more scalable than current green hydrogen (electrolysis of water) since no precious metal catalysts, membranes, or desalinated water are needed. Further, the co-production and projected sale of graphene is estimated to result in negative cost of H₂ production, allowing this method of production and waste upcycling to be economically viable and to easily compete with even the cheapest (and most environmentally degrading) production method, namely grey hydrogen production by steam methane reforming.

Viewing this technology primarily as a H₂ production method, and secondarily as a plastic upcycling method and graphene production method, the methods disclosed herein were compared to existing H₂ production methods by life-cycle assessment and through preliminary estimated production costs. These analyses are shown in FIGS. 23A-23C, which show the (a) cumulative energy demand, (b) greenhouse gas emissions, and (c) estimated production cost resulting from the production of 1 kg H₂ using different methods. Key assumptions used here include that the power source for all methods (electrolysis, FJH, pyrolysis, etc.) is green energy, and that no emissions are contributed from powering each method. The amount of greenhouse gases emitted is thus a result of sourcing materials (Pt, CH₄, fresh water, catalyst, etc.) and any CO₂ produced stoichiometrically by the process. Additionally, the estimated production cost of the “FJH PE H₂” and “FeAlOx PE H₂” processes include the sale of high-value carbon coproducts of graphene and MWCNT, respectively. A sale price of US$16,000 per ton was assumed for the MWCNT, as significant purification will be required to remove the reported ~10 wt % of catalyst. A ‘worst case’ scenario is assumed for the sale price of graphene, at US$3,000 per tonne, to account for possible market saturation. This assumed sale price of graphene at US$3,000 per tonne is 95% lower than actual current market value of multi-layered graphene products (US$60,000 per tonne).

FJH production of H₂ through deconstruction of plastics are competitive with current methods, with respect to cumulative energy demand, greenhouse gas emissions, and is the only method that demonstrated negative estimated production cost. Currently, H₂ is not produced from waste materials on an industrial scale, only in academic publications, which typically use large amounts of metal catalyst. The FJH deconstruction method is compared to other academic methods (shown in TABLE II) to produce H₂ from waste materials in FIG. 23D. This comparison shows that the FJH method produces significantly more H₂ than most methods, while using no metal catalyst.

TABLE II
Literature Values and Sources Used Shown In FIG. 23D

| | Amt | | | Catalyst | Amt | | |
|---|---|---|---|---|---|---|---|
| No. | Cat. | Method | Reforming? | Used | Recovered | | Reference |
| | | Theoretical max in HDPE | | | 71.4 | mmol | |
| | 0% | FJH, no | None | None | 46.59 | mmol | Herein |
| | | reforming | | | | | |
| 2 | 0% | Two stage | None | None | 8.08 | mmol | Yao 2018 |
| | | pyrolysis | | | | | |
| 3 | 33% | Two stage | None | 2:1 | 31.8 | mmol | |
| | | pyrolysis | | FeNiAlO | | | |
| 4 | 33% | Traditional | None | Ni—La/AlO | 15.2 | mmol | Li 2022 |
| | | pyrolysis | | | | | |
| 5 | 0% | Traditional | Yes | None | 3.04 | mmol | Al-asadi 2021 |
| | | pyrolysis | | | | | |
| 6 | 71% | 2/1/4 mixture | Yes | Ce—Ni | 11.4 | mmol | |
| | | of plastic/Ce—Ni- | | Zeolite | | | |
| | | Zeloite | | | | | |
| | | catalysts/ | | | | | |
| | | dolomite, | | | | | |
| | | pyrolysis, | | | | | |
| | | reforming | | | | | |
| 7 | 33% | Same, no | Yes | Ca/Mg/Ni/ | 10.2 | mmol | |
| | | dolmite | | Ci | | | |
| 8 | 50% | Traditional | None | 1:1 FeAlO | 4.3 | mmol | Jie 2020 |
| | | pyrolysis | | | | | |
| 9 | 50% | Microwave | None | 1:1 FeAlO | 55.6 | mmol | |
| | | pyrolysis | | | | | |
| 10 | 50% | Plasma | Yes | Ni/AlO | 4.56 | mmol | Aminu 2020 |
| | | pyrolysis | | | | | |
| 11 | 59% | Plasma | Yes | MCM-41 | 18 | mmol | Aminu 2022 |
| | | pyrolysis | | Zeolite | | | |
| 12 | 59% | Plasma | None | MCM-41 | 11 | mmol | |
| | | pyrolysis | | Zeolite | | | |
| 13 | 33% | Two stage | None | FeNi solgel | 9 | mmol | Jagodzińska |
| | | pyrolysis | | | | | 2022 |
| 14 | 29% | Two stage | None | FeSiO | 25.6 | mmol | Liu 2017 |
| | | pyrolysis | | | | | |
| 15 | 33% | Two stage | None | 1:2 FeAlO | 19.1 | mmol | Acomb 2016 |
| | | pyrolysis | | | | | |
| 16 | 33% | Two stage | None | 1:2 NiAlO | 11.7 | mmol | |
| | | pyrolysis | | | | | |
| 17 | 33% | Two stage | None | 1:2 | 36.2 | mmol | Yao. 2017 |
| | | pyrolysis | | NiFeAlO | | | |
| 18 | 1% | nIR photo | None | PtTi | 26.19 | mmol | Photocatalytic |
| | | dihydrogen | | | | | 2022 |
| 19 | 50% | Microwave | None | 1:1 FeAlO | 48.1 | mmol | Wang 2022 |
| | | pyrolysis | | | | | |

“Amt Cat” refers to the amount of catalyst used; “Amount Rec” refers to the amount recovered (mmol of atomic hydrogen per gram feedstock).

Accordingly, the co-production of high-value graphene results in negative-cost production of H₂ fuels, even if the graphene is sold at 5% of the current market value. The US Department of Energy has indicated that it is committed, in this decade, to producing H₂ for $1 per kg. Here it has been shown that H₂ can be produced for “negative dollars per kg”. More specifically −$4.30 per kg when artificially lowering the price of the graphene to just $3,000/tonne. Meaning that the co-product, graphene, provides such value that there is no cost on the H₂ production, and even negative $4.30/kg. And all this H₂ can come from waste, such as waste plastic, and can also come from cellulosic household waste, construction waste, or manufacturing waste like asphaltenes. The methods and systems disclosed herein provide the stage for the clean fuel needed for the rest of this Century, while removing waste from our landfills.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims. When scaling a process form the laboratory to manufacturing, many of the process and materials need to be modified. Such as quartz tubes changing to concrete or brick or mullite housings. Plastic tubing changing to steel tubing. DC capacitors changing to AC electrical Joule heating. Gas capture and units to large-scale steel that is H₂ resistant for capture and separation.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±100 of the perpendicular and parallel directions, respectively, in some embodiments within ±5° of the perpendicular and parallel directions, respectively, in some embodiments within ±1 of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B. C, and D individually, but also includes any and all combinations and subcombinations of A. B, C. and D.

### REFERENCES

Abe, J. O., et al., “Hydrogen energy, economy and storage: Review and recommendation,” Int. J. Hydrog. Energy, 2019, 44, 15072-15086 (“Abe 2019”).
Acomb, J., et al., “The Use Of Different Metal Catalysts For The Simultaneous Production Of Carbon Nanotubes And Hydrogen From Pyrolysis Of Plastic Feedstocks,” Appl. Catal. B.: Environ., 2016, 180, 497-510 (“Acomb 2016”).
Al-asadi M., et al., “Hydrogen rich products from waste HDPE/LDPE/PP/PET over Me/Ni-ZSM-5 catalysts combined with dolomite,” J. Energy Inst., 2021, 96, 251-259 (“Al-asadi 2021”).
Al-Salem, S. M, et al., “A review on thermal and catalytic pyrolysis of plastic solid waste (PSW),” J. Environ. Manage., 2017, 197, 177-198 (“Al-Salem 2017”).
Aminu, I., et al., “Hydrogen Production by Pyrolysis-Nonthermal Plasma/Catalytic Reforming of Waste Plastic over Different Catalyst Support Materials,” Energy Fuels, 2022, 36(7), 3788-3801 (“Aminu 2022”).
Aminu, I., et al., “Hydrogen from Waste Plastics by Two-Stage Pyrolysis/Low-Temperature Plasma Catalytic Processing,” Energy Fuels, 2020, 34(9), 11679-11689 (“Aminu 2020”).
Barbarias, I., et al., “A sequential process for hydrogen production based on continuous hdpe fast pyrolysis and in-line steam reforming,” Chem. Eng. J., 2016, 296, 191-198 (“Barbarias 2016”).
Beckham, J. L., et al., “Machine Learning Guided Synthesis of Flash Graphene,” Adv. Mater., 2022, 34, 2106506 (“Beckham 2020”).
Beswick. R. R. et al., “Does the Green Hydrogen Economy Have a Water Problem?” ACS Energy Lett., 2021, 6, 3167-3169 (“Beswick 2021”).
Bets, K. V., et al., “Spontaneous Twist And Intrinsic Instabilities Of Pristine Graphene Nanoribbons,” Nano Res., 2009, 2, 161 (“Bets 2009”).
Brenner, D. W., et al., “A Second-Generation Reactive Empirical Bond Order (REBO) Potential Energy Expression For Hydrocarbons,” J. Phys. Condens. Matter, 2002, 14, 783 (“Brenner 2002”).
Contreras, C. S., et al., “Laboratory Investigations Of Polycyclic Aromatic Hydrocarbon Formation And Destruction In The Circumstellar Outflows Of Carbon Stars,” Astrophys. J. Suppl. Ser., 2013, 208, 6 (“Conteras 2013”).
Deng, B., et al., “Urban mining by flash Joule heating.” Nat. Commun., 2021, 12, 5794 (“Deng 2021”).
Dincer, I., “Green methods for hydrogen production,” Int. J. Hydrog. Energy, 2012, 37, 1954-1971 (“Dincer 2012”).
Geyer, R., et al., “Production, use, and fate of all plastics ever made,” Sci. Adv., 2017, 3(7), e1700782 (“Geyer 2017”).
Grigoriev, S, et al., “Current status, research trends, and challenges in water electrolysis science and technology,” Int. J. Hydrogen Energy, 2020, 45, 26036-26058 (“Grigoriev 2020”).
Hermesmann, M., et al., “Green, Turquoise, Blue, or Grey?Environmentally friendly Hydrogen Production in Transforming Energy Systems,” Prog. Energy Combust. Sci., 2022, 90, 100996 (“Hermesmann 2022”).
Holladay, J. D., et al., “An overview of hydrogen production technologies,” Catal. Today, 2009, 139, 244-260 (“Holladay 2009”).
Jagodzinska. K., et al., “Pyrolysis And In-Line Catalytic Decomposition Of Excavated Landfill Waste To Produce Carbon Nanotubes And Hydrogen Over Fe- And Ni-Based Catalysts—Investigation Of The Catalyst Type And Process Temperature,” Chem Eng J, 2022, 446(1). 136808 (“Jagodzinska 2022”).
Jie, X., et al., “Microwave-initiated catalytic deconstruction of plastic waste into hydrogen and high-value carbons,” Nat. Catal., 2020, 3, 902-912 (“Jie 2020”).
Kokai, F., et al., “Fabrication of some graphitic polyhedra and balloon-like particles,” Diam. Relat. Mater., 2007, 16, 1264 (“Kokai 2007”).
Li, J., et al., “Hydrogen-Rich Gas Production with the Ni—La/Al₂O₃—CaO—C Catalyst from Co-Pyrolysis of Straw and Polyethylene.” Catalysts, 2022, 12(5), 496 (“Li 2022”).
Liu, X, et al., “Development Of Ni- And Fe-Based Catalysts With Different Metal Particle Sizes For The Production Of Carbon Nanotubes And Hydrogen From Thermo-Chemical Conversion Of Waste Plastics,” J Anal Appl Pyrolysis, 2017, 125, 32-39 (“Liu 2017”).
Lopes, L. C. et al., “Facile Room Temperature Synthesis Of Large Graphene Sheets From Simple Molecules,” Chem. Sci., 2018, 9, 7297 (“Lopes 2018”).
Lopez, G., et al., “Thermochemical routes for the valorization of waste polyolefinic plastics to produce fuels and chemicals. A review,” Renew. Sust. Energ. Rev, 2017, 73, 346-368 (“Lopez 2017”).
Luong, D. X., et al., “Gram-scale bottom-up flash graphene synthesis,” Nature, 2020, 577, 647-651 (“Luong 2020”).
Miao, M. S. et al., “Density Functional Calculations On The Structure Of Crystalline Polyethylene Under High Pressures,” J. Chem. Phys., 2001, 115, 11317 (“Miao 2001”).
Nikolaidis, P., et al., “A comparative overview of hydrogen production processes,” Renew. Sustain. Energy Rev., 2017, 67, 597-611 (“Nikolaidis 2017”).
Petersen. J. C., in Dev. Pet. Sci. (Eds.: T. F. Yen. G. V. Chilingarian), Elsevier, 2000. pp. 363-399 (“Petersen 2000”).
“Photocatalytic hydrogen production from alkanes. Nat Energy, 2022, 7, 1011-1012 (“Photocatalytic 2022”).
Sathishkumar, T., et al., “Glass fiber-reinforced polymer composites-a review,” J. Reinf Plast. Compos., 2014, 33, 1258-1275 (“Sathishkumar 2014”).
Shiva Kumar, S., et al., “An overview of water electrolysis technologies for green hydrogen production,” Energy Rep., 2022, 8, 13793-13813 (“Shiva Kumar 2022”).
Stanford, M. G., et al., “Flash Grapehene Morphologies,”, ACS Nano. 2020, 14, 13691 (“Stanford 2020”).
Stuart, S. J., et al., “A Reactive Potential For Hydrocarbons With Intermolecular Interactions,” J Chem. Phys. 2000, 112, 6472 (“Stuart 2000”).
Timmerberg, S, et al., “Hydrogen and hydrogen-derived fuels through methane decomposition of natural gas—GHG emissions and costs,” Energy Convers. Manag. X 2020 7, 100043 (“Timmerberg 2020”).
van Renssen, S., “The hydrogen solution?” Nat. Clim. Change, 2020, 10, 799-801 (“van Renssen 2020”).
Velazquez Abad, A., et al., “Production of Hydrogen,” in Encyclopedia of Sustainable Technologies, (ed. Abraham, M. A.) (Elsevier) 2017, 293-304 (“Velazquez 2017”).
Wang, H., et al., “Simultaneous Achievement of High-Yield Hydrogen and High-Performance Microwave Absorption Materials from Microwave Catalytic Deconstruction of Plastic Waste,” Processes, 2022, 10(4), 782 (“Wang 2022”).
Webster, I. J., et al., “Photochemical Synthesis and Spectroscopy of Covalent PAH Dimers,” J. Phys. Chem. A, 2022, 126, 1144 (“Webster 2022”).
Williams, P. T., “Hydrogen and Carbon Nanotubes from Pyrolysis-Catalysis of Waste Plastics: A Review, Waste Biomass Valorization, 2021, 12, 1-28 (Williams 2021”).
Wyss, K. M, et al., “Large-Scale Syntheses of 2-D Materials: Flash Joule Heating and Other Methods,” Adv. Mater., 2022, 34(8), 2106970 (“Wvss I2022”).
Wyss, K. M, et al., “Upcycling end-of-life vehicle waste plastic into flash graphene,” Commun. Eng., 2022, 1, 1-12 (“Wyss II 2022”).
Wyss, K. M, et al., “Holey and Wrinkled Flash Graphene from Mixed Plastic Waste,” ACS Nano, 2022, 16, 7804 (“Wyss III 2022).
Wyss, K. M, et al., “Converting Plastic Waste Pyrolysis Ash Into Flash Graphene,” Carbon, 2021, 174, 430 (“Wyss 2021”).
Yao, D., et al., “Co-Production Of Hydrogen And Carbon Nanotubes From Real-World Waste Plastics: Influence Of Catalyst Composition And Operational Parameters,” Appl. Catal. B., 2018, 221, 584-597 (“Yao 2018”).
Yao, D., et al., “Co-Production Of Hydrogen And Carbon Nanotubes From Catalytic Pyrolysis Of Waste Plastics On Ni—Fe Bimetallic Catalyst,” Energy Convers. Manag, 2017, 148, 692-700 (“Yao 2017”).

1. A method comprising:
producing hydrogen gas from solid material using flash Joule heating.

2. The method of claim 1, wherein the solid material is a waste product.

3. The method of claim 1, wherein the solid material is plastic.

4. (canceled)

5. The method of claim 1, wherein the solid material is cellulosic.

6-9. (canceled)

10. The method of claim 1, wherein the method co-produces one or more of the following: graphene, carbon nanotubes, 1-dimensional materials, amorphous carbon, graphite nanodiamond, and silicon carbide.

11. The method of claim 10, wherein the method co-produces silicon carbide selected from the group consisting of nanofibrils, nanotubes, and nanowhiskers.

12. The method of claim 10, wherein the method co-produces 1-dimensional materials selected from the group consisting of nanofibrils, nanotubes, and nanowhiskers.

13. (canceled)

14. The method of claim 1, wherein hydrocarbons are co-produced.

15-17. (canceled)

18. The method of claim 1, wherein carbon monoxide, carbon dioxide, or mixtures thereof are co-produced.

19. (canceled)

20. The method of claim 1, wherein the method co-produces 1-dimensional materials selected from the group consisting of heteroatom-containing 1-dimensional materials.

21-22. (canceled)

23. The method according to claim 1, wherein the solid material is selected from the group consisting of coal, a coal derivative, a petroleum derivative, a petroleum product, a carbon-containing material, glass mixed with plastic, glass fiber plus plastic, glass fiber plus carbon fiber, and combinations thereof.

24. The method of claim 1, wherein the flash Joule heating is performed catalyst-free.

25. The method of claim 1, wherein the flash Joule heating is performed using a catalyst.

26-27. (canceled)

28. The method of claim 25, wherein the catalyst is selected from the group consisting of iron chloride, ferrocene, mixtures of iron chloride/nickel chloride, cobalt salts, cobalt oxide, and combinations thereof.

29. A method comprising:
producing hydrogen gas from material using flash Joule heating, wherein the material comprises a liquid that has hydrogen atoms chemically present.

30. The method of claim 29, wherein the liquid has carbon and hydrogen chemically present.

31. The method of claim 29, wherein the liquid is selected from the group consisting of crude oil, oil, asphalt, and combinations thereof.

32. The method of claim 29, wherein the liquid is absorbed on a sponge.

33. (canceled)

34. The method of claim 29, wherein the flash Joule heating is performed catalyst-free.

35. The method of claim 29, wherein the flash Joule heating is performed using a catalyst.
